(19) United States
(12) Patent Application Publication
(10) Pub. No.: US 2009/0100566 A1
(43) Pub. Date: Apr. 23, 2009

(54) NON-SLIP EMBLEMS AND THEIR APPLICATION TO BABY CLOTHING

(76) Inventors: Shannon Schiavino, Flemington, NJ (US); Gary Schiavino, Flemington, NJ (US)

Correspondence Address: WOOD AND EISENBERG, PLLC, 6911 RICHMOND HIGHWAY, SUITE 403, Alexandria, VA, 22306, US

(21) Appl. No.: 12/254,792

(22) Filed: Oct. 20, 2008

Related U.S. Application Data
(60) Provisional application No. 60/980,933, filed on Oct. 18, 2007.

(51) Int. Cl. A41D 11/00; A41D 27/08; B41F 33/00

(52) U.S. Cl. 2/80; 2/244; 101/483

(57) ABSTRACT

A non-skid means for helping prevent slip accidents with respect to infants in which a baby garment is provided having front and rear sides, the rear side comprising an external fabric surface, the external fabric surface of the rear side comprising thereon a plurality of non-slip rubber emblems each having an overall predetermined decorative shape, wherein each of the plurality of non-slip rubber emblems comprises at least one layer of cured low viscosity silicone rubber applied by a silk screen printing process in which low viscosity liquid silicone rubber is used in place of ink.

### CROSS-REFERENCE TO RELATED APPLICATIONS

This application claims the benefit of priority from U.S. Provisional Patent Application Ser. No. 60/980,933, filed Oct. 18, 2007, the entire contents of which are incorporated herein by reference.

### STATEMENT REGARDING FEDERALLY SPONSORED RESEARCH OR DEVELOPMENT

Not Applicable.

### FIELD OF THE INVENTION

This invention relates generally to non-slip emblems and more particularly to their use in combination with baby clothes to help babies maintain an upright position instead of sliding down.

### BACKGROUND OF THE INVENTION

A baby typically lacks coordination and is prone to slide out of devices such as, but not limited to, baby chairs, car seats and swings.

U.S. Pat. No. 4,845,778 patent describes a child's crawler garment and a method of making the garment which is a pair of pants having leg portions which are formed in the vicinity of the knee area with a design made of a thermal heat settable material which, when subjected to heat, is caused to raise slightly above the surface of the garment to form an anti-skid surface to prohibit a crawling infant from sliding or falling. Also, an embossed or roughened knee area may provide for an anti-slip surface.

U.S. Pat. No. 6,708,342 describes an article of clothing for an infant that includes a body, such as a band, a sock, a pair of pants, a shirt or a jumper, formed of one material and an attached gripper member formed of another material having a greater coefficient of friction than that of the first material. The gripper member is positioned on an upper, bottom and/or side surface of a foot portion, a knee area or an elbow area to assist a crawling or recently walking infant. A pad can be superposed with the gripper member in the knee area or the elbow area.

There is a need for an apparatus for safely preventing babies from inadvertently sliding out of devices otherwise designed to hold them safely in place.

### SUMMARY

A non-skid means for helping prevent slip accidents with respect to infants in which a baby garment is provided having front and rear sides, the rear side comprising an external fabric surface, the external fabric surface of the rear side comprising thereon a plurality of non-slip rubber emblems each having an overall predetermined decorative shape, wherein each of the plurality of non-slip rubber emblems comprises at least one layer of cured low viscosity silicone rubber applied by a silk screen printing process in which low viscosity liquid silicone rubber is used in place of ink.

### BRIEF DESCRIPTION OF THE DRAWINGS

FIGS. 1 through 10 show various aspects of the present invention.

### DESCRIPTION OF THE INVENTION

This invention is directed to non-slip emblems and more particularly to their use in combination with baby clothes to help babies maintain an upright position instead of sliding down.

For the purposes of this patent the terms “infant” and “baby” are regarded as equivalent terms; and the terms “baby-clothing”, “infant clothing”, “baby-garment” and “infant garment” are regarded as equivalent terms.

In one embodiment of the present invention, non-slip rubber emblems are affixed to the posterior and/or rear area of infant clothing as three-dimensional patterns by means of a liquid silicone rubber curing process to the posterior area and/or the rear of infant clothing. For example, non-slip rubber emblems of predetermined shape and colors can be affixed to the posterior area and/or the rear area of articles of baby clothing such as one-piece baby garments, e.g., a onesie (i.e., an infant bodysuit) and an infant sleep-suit, baby pants, baby shorts, and any kind of baby rompers. Baby clothing apparel fitted with such non-slip rubber emblems will help mothers by reducing the tendency of babies to slip down or out of such devices as bouncy baby chairs, car seats, swings, etc. The non-slip rubber emblem provides friction to the infant's behind and/or rear of the infant. This friction helps keep the infant in an upright position. A baby scrunched down in a baby seat such as a car seat is less comfortable than a baby in an upright position and mothers do not have to repeatedly reposition their baby.

Silicone color pigments that can be used to add color to liquid silicone can be any suitable coloring pigment such as, but not limited to: Silc-Pig® color pigments.

Preferably, the viscosity of the liquid silicone rubber prior to curing is in the range of 2 to 500,000 poises at 20° C. (twenty Celsius), more preferably 1,000 to 50,000 poises at 20° C. (twenty Celsius), still more preferably in the range 2 to 50 poises at 20° C. (twenty Celsius), and still more preferably in the range 2 to 20 poises at 20° C. (twenty Celsius); quoted viscosity ranges correspond to one Bar atmospheric pressure. Once cured, the non-slip emblems of the present invention has a hardness in the range 10 to 75 Shore-A hardness, and more preferably in the range 15-55 Shore-A hardness.

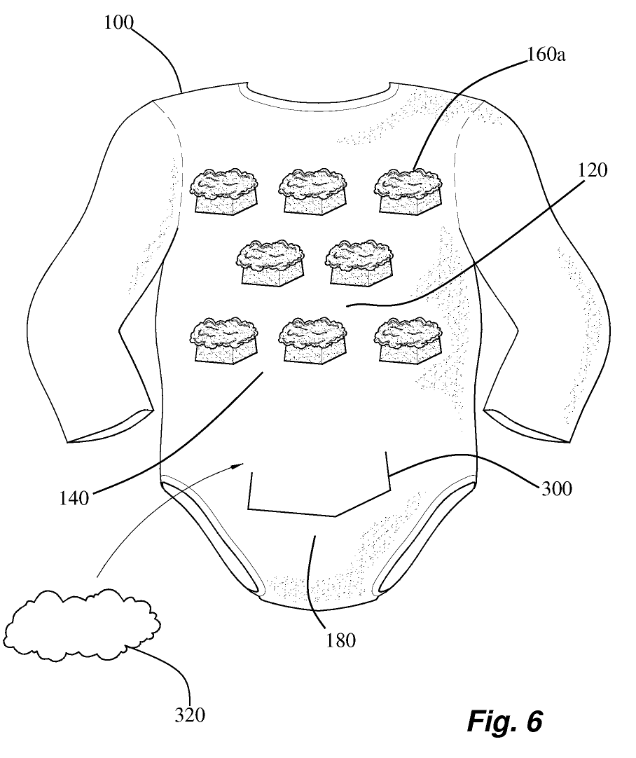

For the purposes of this patent, high viscosity is defined as a liquid silicone rubber composition that prior to the start of curing can sustain a certain height from the support surface (e.g., fabric surface 120) for forming a raised indication without the need for edge containment or sideways support such as that supplied by a supporting border (see, e.g., first and second borders 300 and 320 shown in FIG. 6).

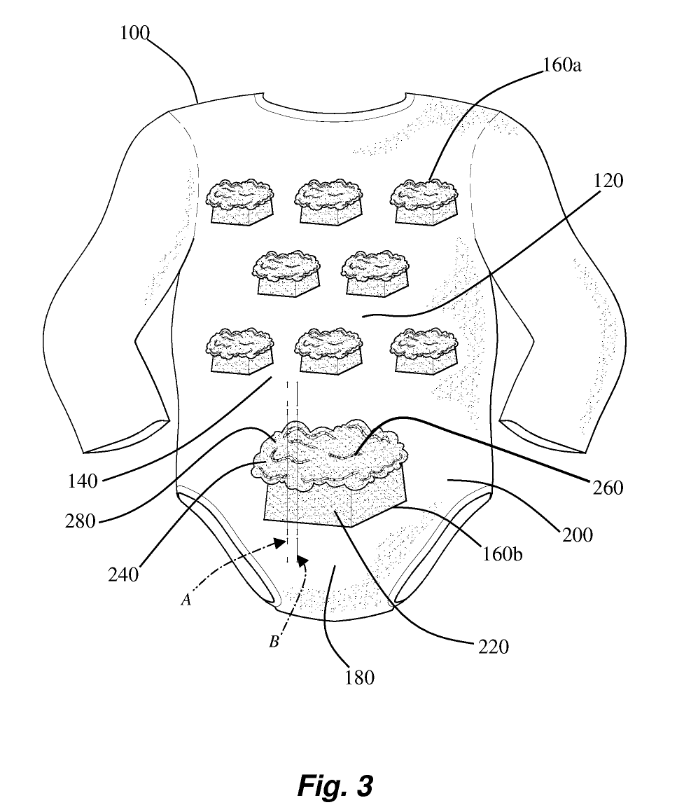

For the purposes of this patent, low viscosity is defined as a liquid silicone rubber composition that prior to the start of curing cannot sustain a certain height from the support surface (e.g., fabric surface 120) for forming a raised indication unless supported by, for example, a supporting border (see, e.g., first and second borders 300 and 320 shown in FIG. 6). It is preferred that the liquid silicone rubber is sufficiently viscous that it does not penetrate through fabric layer 200 (see, e.g., FIG. 3).

It will be understood by a person of ordinary skill in the art that the quoted measurements of temperature and pressure is not intended to restrict the practice of this invention to 20° C. and one Bar atmospheric pressure.

The liquid silicone rubber composition is preferably a thermosetting or ultraviolet-curable composition. That is, the liquid silicone rubber composition is preferably curable either by heat or by exposure to ultra-violet (UV) light. For example, liquid silicone rubber composition can be cured by irradiation with an ultraviolet ray source at 4.5 J/cm² (4500 mJ/cm²) with a high-pressure mercury lamp. For a given composition and thickness of UV curable liquid silicone rubber, the greater the amount of UV per unit area, the shorter the curing time. Examples of UV curable silicone rubber compositions that can be used in the present invention include, but are not limited to: KE-594 with 40 Shore-A hardness and KE-597 with 70 Shore-A hardness supplied by Shin-Etsu Chemical Company of Tokyo. Alternatively, the liquid silicone rubber composition is of the RTV type (room temperature vulcanizing liquid silicone rubber).

In one embodiment of the present invention liquid silicone rubber is printed on the posterior area and/or the rear of infant clothing by means of a modified screen printing process.

In another embodiment liquid silicone rubber is applied within surface areas defined by borders applied on the posterior area and/or the rear of infant clothing. Borders can be constructed by any suitable means, e.g., such as stitching. Borders can also be deposited as a continuous bead made up of high viscosity liquid silicone rubber that is curable by any suitable means such as, but not limited to, curing at room temperature (RTV liquid silicone rubber), by application of heat (i.e., thermosetting liquid silicone rubber), or cured by intense blue light or ultra-violet light (“UV”) (i.e., light curable liquid silicone rubber). Borders made using high viscosity silicone rubber compositions can be applied using, e.g., a manual applicator or in the alternative a robot applicator such as described in U.S. Pat. No. 5,309,840 issued May 10, 1994 to Takamura et al. The Takumura et al. patent (i.e., U.S. Pat. No. 5,309,840) is incorporated herein by reference in its entirety. For example, the border can be a bead of a high viscosity liquid silicone rubber composition laid down on the posterior and/or rear surface of a baby suit from a nozzle of a robotic applicator of the type described in U.S. Pat. No. 5,309,840.

In one embodiment of the present invention the one-piece baby garment has front and rear sides. The rear side has an external surface with a plurality of non-slip rubber emblems each having a predetermined decorative shape. Each of the non-slip rubber emblems has at least one layer of silicone rubber, and each of the adjacent layers are applied within borders previously deposited on the external surface of the rear side of the one-piece baby garment.

In another embodiment according to the present invention, non-slip emblems are printed to a fabric, comprising the steps of:

(a) applying a plurality of borders to a fabric surface such as the external rear surface of a one-piece baby garment, wherein each border defines an enclosed area of fabric;

(b) applying a low viscosity liquid layer of ultra-violet light (UV) curable silicone rubber to each area inside each border, wherein each layer applied has a pre-selected color;

(c) curing each layer of silicone rubber using ultra-violet light (UV) to provide a non-slip emblem having a predetermined image and shape; and

(d) repeating steps (a) through (c) to provide a plurality of non-slip emblems each having a predetermined image and shape and each providing a non-slip surface.

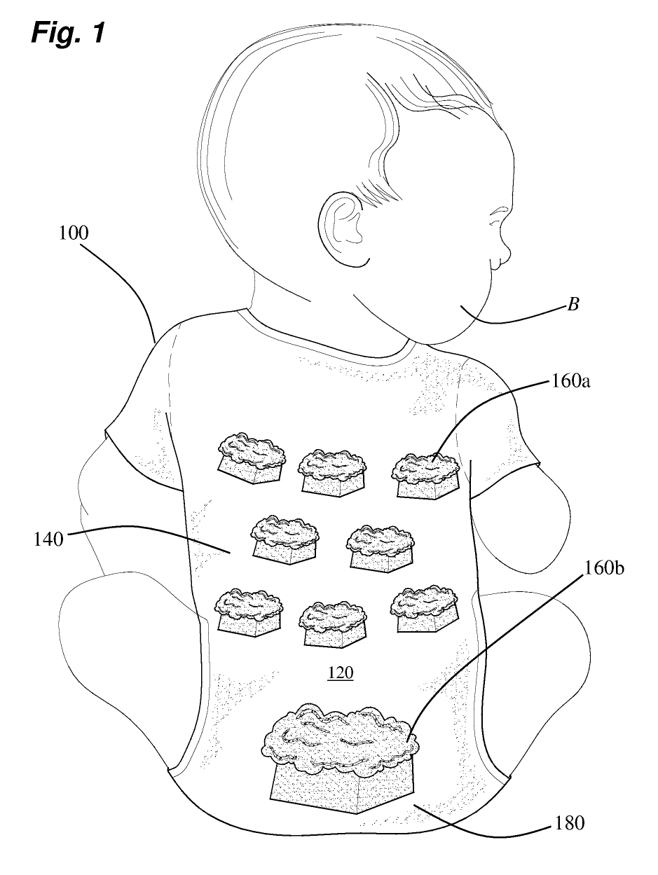

Referring to the Figures, FIG. 1 shows a baby B wearing a an exemplar baby garment in the form of a one-piece baby garment 100, but it should be understood that the present invention can be applied to any kind of baby garment and is expressly not limited to a one-piece baby garment. The exterior fabric surface 120 of the rear side 140 of the baby garment shows a plurality of exemplar non-slip rubber emblems 160 of the present invention. The non-slip rubber emblems 160 are represented in FIG. 1 by numeric labels 160a and 160b, wherein non-slip rubber emblems 160a and 160b are respectively shown fixed to the rear side 140 and posterior area 180 of the one-piece baby garment 100.

It should be understood that the present invention is not limited to a one-piece baby garment. For example, the non-slip rubber emblems 160 can be applied to an infant sleep-suit, baby pants, baby shorts, and any kind of baby rompers.

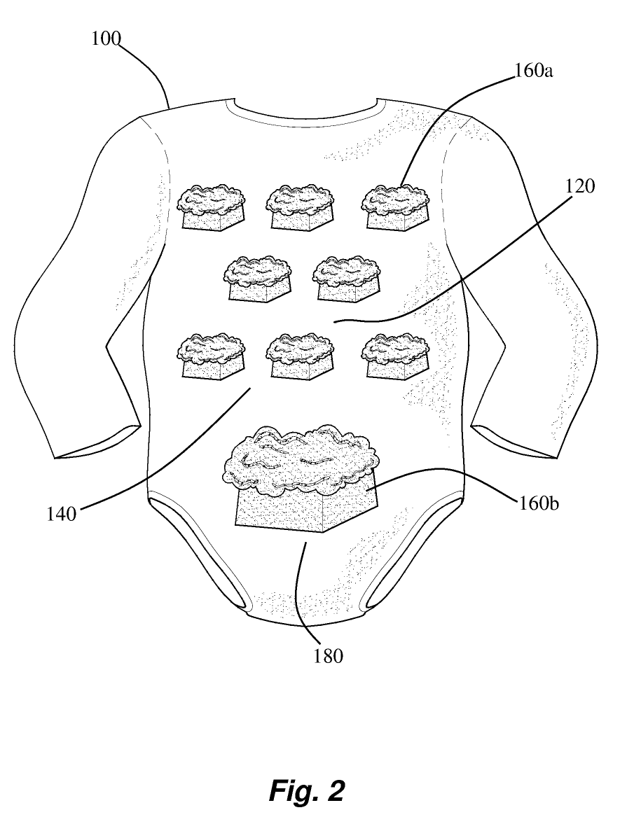

FIG. 2 shows the exterior fabric surface 120 of the rear side 140 of a one-piece baby garment 100 with long sleeves. The non-slip rubber emblems 160 are represented in FIG. 2 by numeric labels 160a and 160b, wherein non-slip rubber emblems 160a and 160b are respectively shown fixed to the rear side 140 and posterior area 180 of the one-piece baby garment 100.

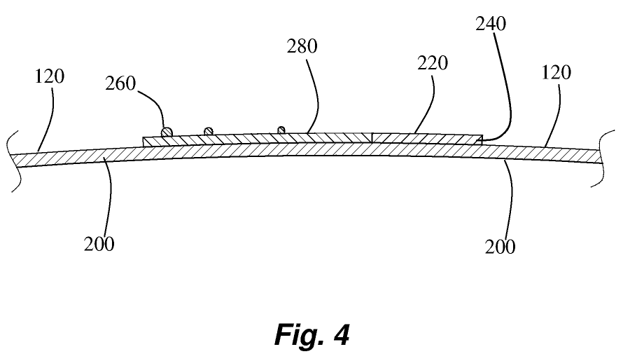

Referring to FIGS. 3 and 4, FIG. 4 shows a detailed view of a section slice taken between lines A and B on FIG. 3. FIG. 4 also shows fabric layer 200 that defines exterior fabric surface 120. First and second layers 220 and 240 of cured silicone rubber are shown affixed to the exterior surface 120 of fabric layer 200. Discrete layers 260 of cured silicone rubber having an overall round cross section shape are shown affixed to the second layer 240 of silicone rubber. The layers 220, 240 and 260 can be different in color. The discrete layers 260 are, for example, twirls aesthetically or decoratively representing curves in, for example, a top coating of a cream bun or sticky bun. First layer 220 represents, for example, the base part of a sticky bun, and the second layer 240 the top part of a sticky bun. The first and second layers 220 and 240 are adjacent each other whereas the discrete layers 260 are shown affixed to the top surface 280 of the second layer 240. Discrete layers 260 can be made up of high viscosity liquid silicone rubber laid down on top of layer 240 is then solidified by curing. The discrete layers 260 can be laid down on top of layer 240 by any suitable means such as, but not limited to, an extruder or from a nozzle of a robotic applicator of the type described in U.S. Pat. No. 5,309,840.

The layers 240 and 260 can be laid down by a silk-screen printing process in which heat curable liquid silicone rubber is the used in place of ink, and the liquid silicone rubber is pumped or squeezed by capillary action to the substrate (i.e., the exterior surface 120 of fabric layer 200. The layers 240 and 260 are then fixed to the exterior surface 120 by either heating (e.g., to between 60° to 200° C., preferable to about 160° C.) for sufficient time to heat cure the silicone rubber to form layer 220 and/or 240. Heat can be supplied by oven heating or infrared heating preferably to 60° to 200° C., preferable to about 160° C.

Alternatively, the layers 240 and 260 can be applied by a silk-screen printing process in which UV curable liquid silicone rubber is the used in place of ink, and the liquid silicone rubber is pumped or squeezed by capillary action to the substrate (i.e., the exterior surface 120 of fabric layer 200. The layers 240 and 260 are then fixed to the exterior surface 120 by exposure to UV light for sufficient time to cure the silicone rubber to form layer 220 and/or 240.

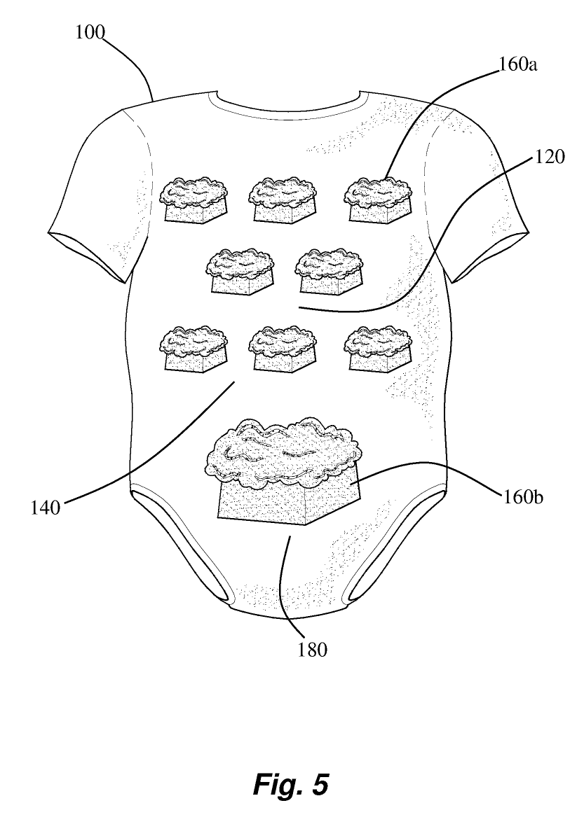

FIG. 5 shows the exterior surface 120 of the rear side 140 of a one-piece baby garment 100 with short sleeves. The non-slip rubber emblems 160 are represented in FIG. 1 by numeric labels 160a and 160b, wherein non-slip rubber emblems 160a and 160b are respectively shown fixed to the rear side 140 and posterior area 180 of the one-piece baby garment 100.

There maybe times when someone practicing the present invention is, for example, limited or constricted to supplies of low viscosity liquid silicone rubber. On such occassions an operator can use a containment or support means such as a stitched border applied to the exterior fabric surface 120, and low viscosity liquid silicone rubber applied within the fabric surface area defined by the stitched border. Such borders may also be provided by laying down a bead of high viscosity liquid silicone rubber and then curing the border by heat or exposure to light such as UV light. Low viscosity liquid silicone rubber is then applied, e.g., by silk screen printing using low viscosity liquid silicone rubber in place of ink, to the surface area defined by the border and the liquid silicone rubber cured.

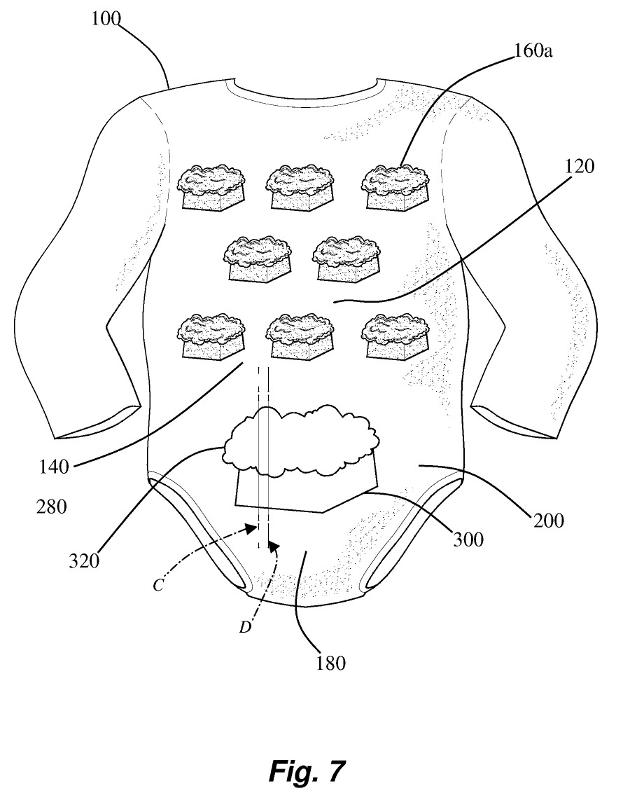

FIG. 6 shows the application of borders, wherein first and second borders 300 and 320 are added to exterior fabric surface 120. FIG. 7 shows the first and second borders 300 and 320 applied to the exterior fabric surface 120.

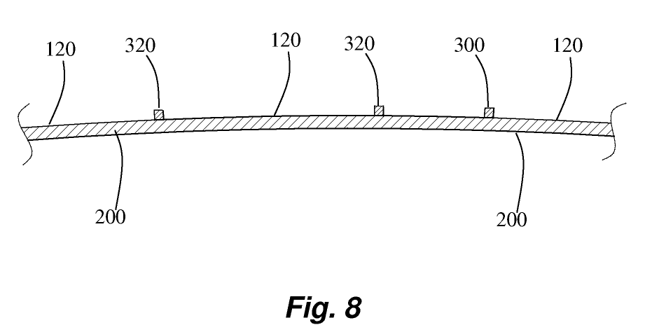

FIG. 8 shows a detailed view of a section slice taken between lines C and D on FIG. 7. FIG. 8 shows fabric layer 200 that defines exterior fabric surface 120 and first and second borders 300 and 320 affixed thereto.

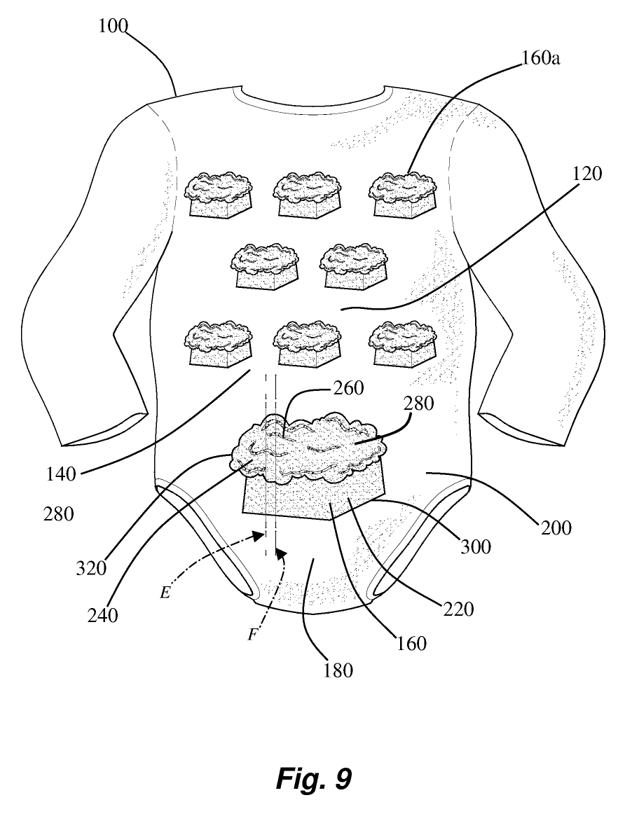

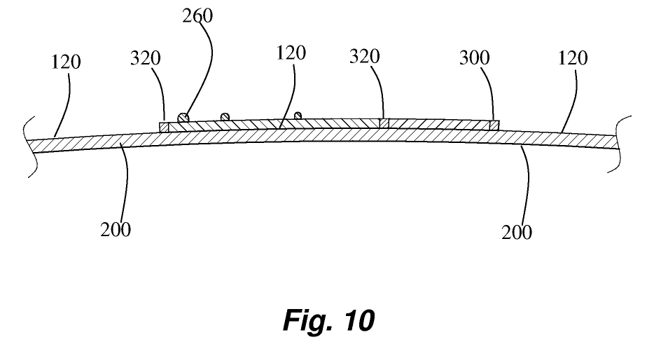

FIG. 9 shows first and second layers 220 and 240 applied within first and second borders 300 and 320 as shown. FIG. 10 shows a detailed view of a section slice taken between lines E and F on FIG. 9.

In one embodiment of the invention a baby garment is provided having front and rear sides, the rear side comprising an external fabric surface, the external fabric surface of the rear side comprising thereon a plurality of non-slip rubber emblems each having an overall predetermined decorative shape, wherein each of the plurality of non-slip rubber emblems comprises at least one layer of cured low viscosity silicone rubber applied by a silk screen printing process in which low viscosity liquid silicone rubber is used in place of ink.

The baby garment can comprise at least one layer of cured low viscosity silicone rubber applied within a surface area of fabric defined by at least one border.

It is to be understood that the present invention is not limited to the embodiments described above or as shown in the attached figure(s), but encompasses any and all embodiments within the spirit of the legal doctrine of equivalence.

What is claimed:

1. A baby garment having front and rear sides, said rear side comprising an external fabric surface, said external fabric surface of said rear side comprising thereon a plurality of non-slip rubber emblems each having an overall predetermined decorative shape, wherein each of said plurality of non-slip rubber emblems comprises at least one layer of cured low viscosity silicone rubber applied by a silk screen printing process in which low viscosity liquid silicone rubber is used in place of ink.

2. The baby garment of claim 1, wherein said at least one layer of cured low viscosity silicone rubber is applied within a surface area of fabric defined by at least one border.

3. A method of printing non-slip emblems to a fabric, comprising the steps of:
(a) applying a plurality of borders to a fabric surface, wherein each border defines an enclosed area of fabric;
(b) applying a layer of silicone rubber to each area inside each border, wherein each layer applied has a pre-selected color;
(c) curing each layer of silicone rubber using ultra-violet light (UV) to provide a non-slip emblem having a predetermined image and shape; and
(d) repeating steps (a) through (c) to provide a plurality of non-slip emblems each having a predetermined image and shape and each providing a non-slip surface.

4. The method of printing non-slip emblems to a fabric according to claim 3, wherein the fabric surface forms the rear part of the exterior surface of a baby outfit.

5. A baby garment having front and rear sides, said rear side comprising an external surface, said external surface of said rear side comprising thereon a plurality of non-slip rubber emblems each having a predetermined decorative shape, wherein each of said plurality of non-slip rubber emblems comprises a plurality of adjacent layers of colored silicone, wherein each of said adjacent layers are applied within borders previously deposited on said external surface of said rear side of said one-piece baby garment.
